(19) United States
(12) Patent Application Publication
(10) Pub. No.: US 2014/0117185 A1
(43) Pub. Date: May 1, 2014

(54) SENSOR MOUNTING APPARATUS

(71) Applicants: HON HAI PRECISION INDUSTRY CO., LTD., New Taipei (TW); HONG FU JIN PRECISION INDUSTRY(ShenZhen) CO., LTD., Shenzhen (CN)

(72) Inventors: CHIH-KUN SHIH, Santa Clara, CA (US); WAN-CHENG LUO, Shenzhen (CN); XIAO-MAO XIE, Shenzhen (CN); WEI XU, Shenzhen (CN); KAI-HUA WU, Shenzhen (CN); YONG-GUI PAN, Shenzhen (CN)

(21) Appl. No.: 13/930,216

(22) Filed: Jun. 28, 2013

(30) Foreign Application Priority Data
Oct. 26, 2012 (CN) 2012104160299

(51) Int. Cl. F16M 13/02

(52) U.S. Cl. CPC F16M 13/02
USPC 248/314

(57) ABSTRACT

A sensor mounting apparatus includes a base, a first installation arm, and a second installation arm. The first installation arm and the second installation arm extend from the base. The first installation arm defines a first installation slot. The second installation arm defines a second installation slot. Each of the first installation slot and the second installation slot configured for receiving two sensors. Central axis of the first installation slot and the second installation slot is arranged in a line.

### BACKGROUND

1. Technical Field

The present disclosure relates to mounting apparatuses, and more particularly to a sensor mounting apparatus.

2. Description of Related Art

A sensor is provided in a bill-counting machine to prevent the bills from being miscounted. In order to secure the sensor, a metal plate is provided. The sensor is secured to the metal plate, and the metal plate is secured to a chassis of the bill-counting machine with screws. Such known securing means makes assembly and disassembly of the bill-counting machine inconvenient. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and two sensors in accordance with an embodiment.

FIG. 2 is similar to FIG. 1, but viewed in a different aspect.

FIG. 3 is an isometric view of assembling the mounting apparatus and the two sensors of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

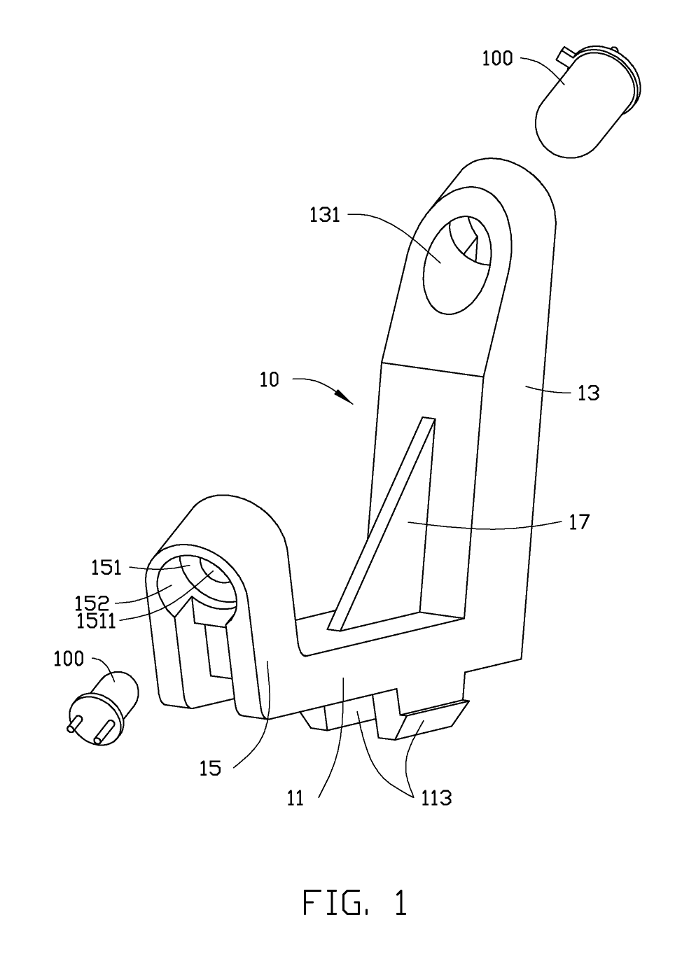

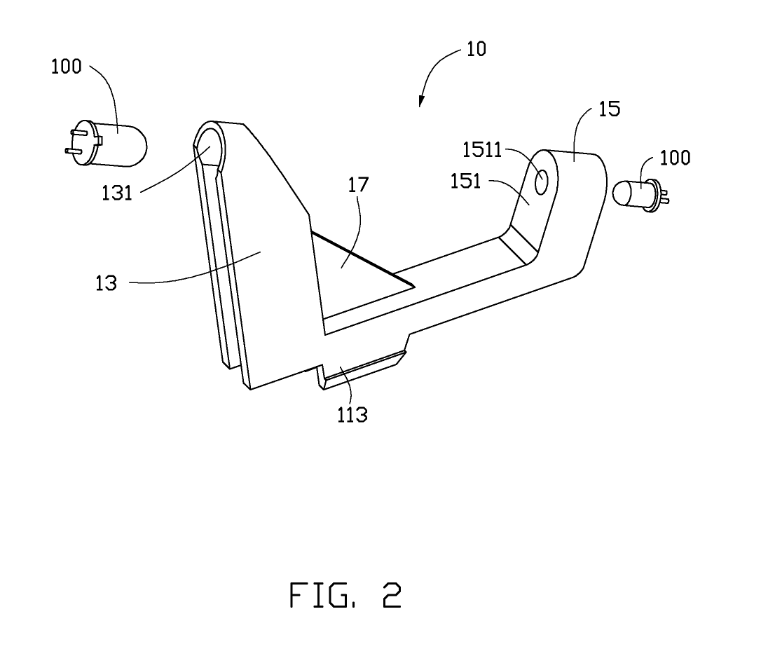

FIGS. 1 and 2 illustrate a mounting apparatus 10 in accordance with an embodiment for securing two sensors 100. The two sensors 100 may be optical sensors, which can be used in bill-counting machine to prevent the bills from being miscounted.

The mounting apparatus 10 comprises a base 11, a first installation arm 13, and a second installation arm 15. The first installation arm 13 is substantially perpendicular to the base 11. An obtuse angle is defined between an extension direction of the second installation arm 15 and the base 11. A height of the first installation arm 13 is greater than that of the second installation arm 15. A rib 17 is located in a corner between the first installation arm 13 and the base 11. The rib 17 is connected to the first installation arm 13 and the base 11. In an embodiment, the rib 17 is triangle.

Two locking portions 113 extend from opposite bottom edges of the base 11. The two locking portions 113 are resiliently deformable and configured to engage with the bill-counting machine, to secure the mounting apparatus 10 to the bill-counting machine.

The first installation arm 13 defines a first installation slot 131 in an end away from the base 11. An acute angle is defined between an extension direction of the first installation slot 131 and the base 11.

The second installation arm 15 has a front wall 151. The front wall 15 defines a through hole 1511. The second installation arm 15 defines a second installation slot 152 in the back of the through hole 1511. The second installation slot 152 is in communication with the through hole 1511. Central axis of first installation slot 131 and the second installation slot 152 are arranged in a line, and an acute angle is defined between the line and the base 11. In an embodiment, the through hole 151 and the second installation slot 152 are circular, and a diameter of the second installation slot 152 is greater than that of the through hole 1511.

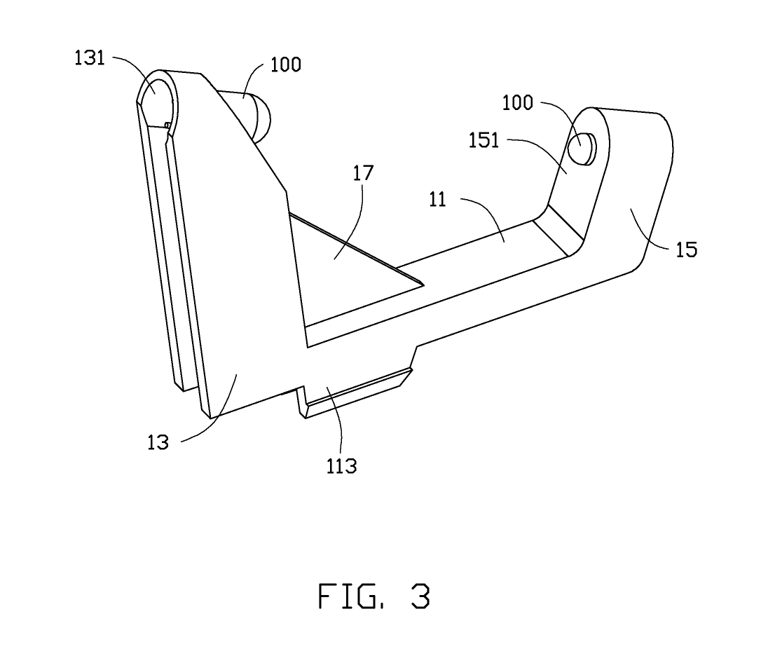

FIG. 3 shows that the two sensors 100 are fixed in the first installation slot 131 and the second installation slot 152. In the embodiment, the sensors are fixed by hot melt. Signals can be transmitted between the two sensors 100.

When the two locking portions 113 are engaged in the bill-counting machine, the mounting apparatus 10 can be thus secured to the bill-counting machine. When the two locking portions 113 are resiliently deformed in opposite directions, the two locking portions 113 can be disengaged from the bill-counting machine.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A sensor mounting apparatus comprising:
a base, a first installation arm, and a second installation arm; each of the first installation arm and the second installation arm extending from the base; the first installation arm defining a first installation slot; the second installation arm defining a second installation slot; the first installation slot and the second installation slot being configured for receiving two sensors; a central axe of the first installation slot and a central axe of the second installation slot are arranged in a line.

2. The sensor mounting apparatus of claim 1, wherein a height of the first installation arm is greater than a height of the second installation arm.

3. The sensor mounting apparatus of claim 1, wherein the first installation arm is substantially perpendicular to the base.

4. The sensor mounting apparatus of claim 1, wherein an obtuse angle is defined between the second installation arm and the base.

5. The sensor mounting apparatus of claim 1, wherein an acute angle is defined between an extension direction of the first installation slot and the base.

6. The sensor mounting apparatus of claim 5, wherein an extension direction of the second installation slot is same to the extension direction of the first installation slot.

7. The sensor mounting apparatus of claim 1, wherein an acute angle is defined between the line and the base.

8. The sensor mounting apparatus of claim 1, wherein a rib is disposed in a corner between the first installation arm and the base, and the rib is connected to the first installation arm and the base.

9. The sensor mounting apparatus of claim 8, wherein the rib is substantially triangle shaped.

10. The sensor mounting apparatus of claim 1, wherein two resilient deformable locking portions are located on the base and configured for securing the base.

11. A sensor mounting apparatus assembly comprising:
two sensors; and
a mounting apparatus, the mounting apparatus comprising a base, a first installation arm, and a second installation arm; each of the first installation arm and the second installation arm extending from the base; the first installation arm defining a first installation slot; the second installation arm defining a second installation slot; a central axe of the first installation slot and a central axe of the second installation slot are arranged in a line; and each of the first installation slot and the second installation slot are configured to receive each of the two sensors.

12. The sensor mounting apparatus assembly of claim 11, wherein a height of the first installation arm is greater than a height of the second installation arm.

13. The sensor mounting apparatus assembly of claim 11, wherein the first installation arm is substantially perpendicular to the base.

14. The sensor mounting apparatus assembly of claim 11, wherein an obtuse angle is defined between the second installation arm and the base.

15. The sensor mounting apparatus assembly of claim 11, wherein an acute angle is defined between an extension direction of the first installation slot and the base.

16. The sensor mounting apparatus assembly of claim 15, wherein an extension direction of the second installation slot is same to the extension direction of the first installation slot.

17. The sensor mounting apparatus assembly of claim 11, wherein an acute angle is defined between the line and the base.

18. The sensor mounting apparatus assembly of claim 11, wherein a rib is disposed in a corner between the first installation arm and the base, and the rib is connected to the first installation arm and the base.

19. The sensor mounting apparatus assembly of claim 18, wherein the rib is substantially triangle shaped.

20. The sensor mounting apparatus assembly of claim 11, wherein two resiliently deformable locking portions are located on the base and configured for securing the base.
